(19) United States
(12) Patent Application Publication
(10) Pub. No.: US 2025/0056115 A1
(43) Pub. Date: Feb. 13, 2025

(54) PREVENTING ACCIDENTAL ENDING OF VIDEO DATA CAPTURE

(71) Applicant: Axon Enterprise, Inc., Scottsdale, AZ (US)

(72) Inventors: Morgan G. Castorena, Phoenix, AZ (US); Karthik Narasimhan, Westin, FL (US); Nicholas R. Gilmour, El Dorado Hills, CA (US)

(21) Appl. No.: 18/801,025

(22) Filed: Aug. 12, 2024

Related U.S. Application Data
(60) Provisional application No. 63/532,308, filed on Aug. 11, 2023.

(51) Int. Cl. H04N 23/60; H04N 23/667

(52) U.S. Cl. CPC H04N 23/64; H04N 23/667

(57) ABSTRACT

A recording device is worn by a user at an incident and is configured to capture video data. During an incident, responsive to the recording device receiving an input to stop video data capture, the recording device determines whether the input to stop video data capture comprises an abnormal input. Responsive to an abnormal input, the recording device provides a request for confirmation to end the video data capture and ends video data capture responsive to receiving confirmation. If confirmation is not received, the recording device continues video data capture.

### CROSS-REFERENCE TO RELATED APPLICATIONS

This application claims priority to U.S. Provisional Application 63/532,308, filed Aug. 11, 2023, which is incorporated by reference herein in its entirety.

### FIELD OF INVENTION

Embodiments of the present invention relate to camera systems and preventing accidental inputs from ending video data capture.

### BACKGROUND

Personnel such as law enforcement officers, first responders, firefighters, and recreationalists use cameras to capture events, so that a video and/or audio record exists regarding what happened in an incident. These cameras may be mounted on vehicles such as cars and drones, and they may also be worn on the body as body-worn cameras. Numerous mounting systems exist to mount cameras to personnel. These systems include a variety of coupling methods including those that enable a body-worn camera to be mounted to a torso or head of a person.

However, body-worn cameras may be accidentally impacted or jostled during incidents. For example, a body-worn camera may be pressed between a torso of a user and the arm of the user in motion, or between two people during an altercation. During these accidental impacts, button presses or other interactions with the body-worn camera may occur, and the body-worn camera may, for example, turn off during an altercation or stop recording during an altercation, thus failing to capture video data of the entire altercation. Since video data captured by body-worn cameras may be important to determine exact events and actions taken later, it is beneficial to ensure that body-worn cameras cannot be accidentally turned off and that recording by body-worn cameras cannot be accidentally stopped during incidents.

### BRIEF DESCRIPTION OF THE DRAWINGS

FIG. 1 depicts an environment including one or more cameras and a computing device, according to some embodiments.

FIG. 2 depicts an example recording device, according to some embodiments.

FIG. 3A depicts an example architecture for a recording device, according to some embodiments.

FIG. 3B depicts an example architecture for a computing device, according to some embodiments.

FIG. 4 is a flowchart illustrating a method for requesting confirmation for ending video data capture by a body-worn camera, according to some embodiments.

FIG. 5 is a flowchart illustrating a method for ending video data capture by a body-worn camera, according to some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected, or the like may include permanent, removable, temporary, partial, full, and/or any other possible attachment option. Additionally, any reference to without contact (or similar phrases) may also include reduced contact or minimal contact.

Systems, methods, and apparatus are provided herein. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment.

In various embodiments, an electronic circuit of an electronic device may be configured as a processor that comprises any circuitry and/or electrical/electronic subsystem for performing a function of the electronic device and/or an operation of the electronic device discussed herein. For example, the processor may comprise a processing circuit, a processor, a digital signal processor, a microcontroller, a microprocessor, an application specific integrated circuit (ASIC), a programmable logic device, logic circuitry, state machines, MEMS devices, signal conditioning circuitry, communication circuitry, a computer, a computer-based system, a radio, a network appliance, a data bus, an address bus, and/or any combination thereof. In various embodiments, the processor may include passive electronic devices (e.g., resistors, capacitors, inductors, etc.) and/or active electronic devices (e.g., op amps, comparators, analog-to-digital converters, digital-to-analog converters, programmable logic, SRCs, transistors, etc.). In various embodiments, the processor may include data buses, output ports, input ports, timers, memory, arithmetic units, and/or the like.

The processor may be configured to provide and/or receive electrical signals whether digital and/or analog in form. The processor may provide and/or receive digital information via a data bus using any protocol. The processor may receive information, manipulate the received information, and provide the manipulated information. The processor may store information and retrieve stored information. Additionally, the processor may be associated with an amount of memory that is utilized by the processor to store information and retrieve stored information from within. Information received, stored, and/or manipulated by the processor may be used to perform a function, control a function, and/or to perform an operation or execute a stored program.

The processor may control the operation and/or function of other circuits and/or components of a recording device (e.g., the electronic device). The processor may receive status information regarding the operation of other components, perform calculations with respect to the status information, and provide commands (e.g., instructions) to one or more other components. The processor may command another component to start operation, continue operation, alter operation, suspend operation, cease operation, or the like. Commands and/or status may be communicated between the processor and other circuits and/or components via any type of bus (e.g., SPI bus) including any type of data/address bus.

In various embodiments, an amount of memory may comprise a tangible, non-transitory computer-readable memory. Instructions stored on the tangible non-transitory memory may allow an associated processor and/or other processing circuits to perform various operations, functions, and/or steps associated with a device. For example, in response to the processor executing the instructions on the tangible non-transitory memory, the processor may communicate with image capture modules to capture image data, audio capture modules to capture audio data, initiate capture of image data and/or audio data, end capture of the image data and/or audio data, and/or the like, as discussed further herein. Additionally, the amount of memory may also be configured to receive, store, and maintain incident recordings, including captured image data and audio data. In that regard, the memory may include a storage medium, data structure, database, memory unit, hard-disk drive (HDD), solid state drive (SSD), removable memory, and/or the like.

In various embodiments, a “memory unit” as discussed herein may comprise any hardware, software, and/or database component capable of storing and maintaining data. For example, a memory unit may comprise a database, data structure, memory component, or the like. A memory unit may comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like. It should be noted that any memory unit, storage component, and/or amount of memory may utilize data structures and/or databases that include relational, hierarchical, graphical, distributed ledger, blockchain, object-oriented structure, and/or any other data storage configurations. Additionally, data structures and/or databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Moreover, a database may be organized in any suitable manner, for example, as data tables or lookup tables. Each record stored in a database may be a single file, a series of files, a linked series of data fields, and/or any other data structure or schema.

In various embodiments, a database, system, device, server, amount of memory, memory unit, or other data storage components of the system described herein may consist of any combination thereof at a single location or at multiple locations. For example, any database described herein may comprise a single database or a plurality of databases (virtual partitions or physically distinct). Each database or system may include any of various suitable security features, such as firewalls, access codes, encryption, decryption, compression, decompression, and/or the like.

In various embodiments, “user interfaces” may comprise input devices that utilize hardware and/or software used to provide data, inputs, control signals, and the like to a computer-based system, software application, etc. For example, a user interface configured as an input device may include a pointing device (e.g., mouse, joystick, pointer, etc.), a keyboard (e.g., virtual or physical), a touchpad or touchscreen interface, a video input device (e.g., camera, scanner, multi-camera system, etc.), a virtual reality system, an audio input device (e.g., microphone, digital musical instrument, etc.), a biometric input device (e.g., fingerprint scanner, iris scanner, etc.), a composite device (e.g., a device having a plurality of different forms of input), and/or any other input device.

In various embodiments, “user interfaces” may comprise output devices that utilize hardware and/or software configured to convert information into a human-accessible form, for display, projection, or physical reproduction. For example, a user interface configured as an output device may include a display device (e.g., monitor, monochrome display, colored display, CRT, LCD, LED, projector, video card, etc.), an audio output device (e.g., speaker, headphones, sound card, etc.), a location services system (e.g., global positioning system (GPS), etc.), a printer (e.g., dot matrix printer, inkjet printer, laser printer, 3D printer, wide-format printer, etc.), a braille reader, a composite device (e.g., a device having a plurality of different forms of output), and/or any other output device.

In various embodiments, an incident (or similar terms and phrases, such as an emergency or event) refers to human or animal activities and to a period of time while these activities take place. An incident may include, for example, formation of agreements, transactions, negotiations, discussions, ceremonies, meetings, medical procedures, sporting events, crimes, attempted crimes, disagreements, assaults, conflicts, discoveries, research, investigations, surveillance, and/or the like. Additionally, an incident may be associated with and/or include consequences that occur as a result of, as an effect of, in relation to, and/or otherwise in association with the incident. For example, one or more consequences of an incident may include changes to property such as improvements, repairs, construction, production, manufacture, growth, harvesting, damage, loss, theft, burglary, arson, goods damaged in shipment, conditions of real estate, and/or conditions of agricultural and forestry property. Consequences associated with an incident may include damage to property and/or injury to persons or animals. Damage to property or injury to persons or animals may be accidental or brought on by the action or failure to act of one or more persons. Incidents may be associated with and/or include incident information that may be valuable or otherwise important, helpful, or needed for risk management, insurance, claims, achievements, sports records, news reporting, entertainment, and/or the like.

One or more incident responders may respond or help before, during, or after an incident. For example, in response to an incident including a fire (e.g., burning building, house fire, etc.), incident responders may typically include a law enforcement officer, a firefighter, and/or a medical responder (e.g., an emergency medical technician (EMT), a paramedic, an ambulance technician, etc.). As a further example, in response to an incident including a crime or attempted crime, incident responders may include one or more law enforcement officers.

Incident information (e.g., qualitative data, quantitative data, audio information, visual information, location information, environmental information, etc.) gathered about an incident. Additionally, incident information may include descriptions, opinions, testimony, and/or other statements regarding the incident. Further, incident information may include facts about the activities of the incident, consequences of the incident, time of the incident, and identities associated with humans, animals, or objects related to the incident. Incident information may be recorded as and/or form a report a report of an incident (e.g., an incident report). Incident information about the incident may be gathered before, during, or after an incident. Incident information may be recorded (e.g., audio, video) to document an incident at the time of occurrence.

Incident recording may capture at least a set of incident information associated with the incident. Incident recording further protects against loss of incident information, for example, by physical loss or by faulty human memory. For example, incident responders may capture audio and/or visual information of the incident. The audio and/or visual information may be captured by an incident recording device, such as, for example, a body-worn camera, a smart phone or internet of things (IoT) device, a vehicle-mounted camera, a surveillance camera, and/or any other recording device discussed herein. The recording device may be physically located at a scene of the incident to capture the information about the incident.

An incident recording device may capture incident information from a fixed position (e.g., a fixed field of view, a fixed vantage point, etc.). A fixed position may comprise a position that does not follow or align with a field of view or perception of an incident responder during the incident. The fixed position may be defined relative to an object to which the recording device is attached. For example, a body-worn camera may capture a fixed position from the body of the incident responder, a vehicle-mounted camera may capture a fixed position from the vehicle, etc. The fixed position may include information that is not within the visual perspective (e.g., visual point of view) of the incident responder. The fixed position may not capture all information that is within the visual perspective of the incident responder. For example, the responder may turn their head, resulting in a misalignment between a direction (e.g., forward direction) of a fixed field of view of a chest-mounted body worn camera and the direction (e.g., lateral or vertical direction) of the visual point of view of the responder.

An incident recording device may capture incident information from a dynamic position (e.g., a dynamic field of view, a dynamic vantage point, etc.). A dynamic position may comprise a position that moves, changes, and/or otherwise alters a field of view and/or perception during the incident. Alternatively, or in additionally, the dynamic position may comprise a position that follows and/or aligns with a field of view or perception of an incident responder during the incident. The dynamic position may be defined relative to an object to which the recording device is attached. For example, a body-worn camera may capture a dynamic position aligned to an incident responder field of view by being mounted to a head of the incident responder. The dynamic position may include information that is not within the visual perspective (e.g., visual point of view) of the incident responder (e.g., the incident recording device comprises a fish-eye lens and/or a 360-degree lens to capture information not within the visual perspective of the incident responder). The dynamic position may not capture all information that is within the visual perspective of the incident responder.

In the following description and throughout the disclosure, the terms “recording device” and “camera” may be used interchangeably. It will be apparent to one skilled in the art that each of these terms refers to a device capable of capturing one or more of video, audio, and/or image data and transmitting the video, audio, and/or image data via a communications network.

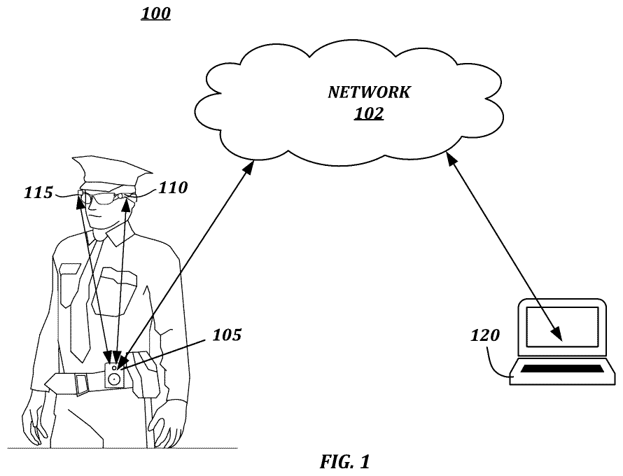

In various embodiments, and with reference to FIG. 1, a recording system 100 is disclosed. The recording system 100 may be configured to selectively capture incident information from a plurality of vantage points. For example, the recording system 100 may be configured to capture incident information from one or more fields of view. At least a portion of recording system 100 may capture a visual point of view at least partially aligned with a point of view of the incident responder. In various embodiments, and as discussed further herein, the recording system 100 may be configured to provide a plurality of interconnected recording devices, each recording device configured to capture incident information at a different vantage point. In various embodiments, and as discussed further herein, the recording system 100 may comprise a single recording device comprising detachable components configured to capture incident information at different vantage points.

In various embodiments, a recording system 100 may comprise one or more recording devices 105, 110, 115, each recording device of the one or more recording devices having a respective housing. For example, a first housing may include a first recording device 105 (e.g., a primary recording device), and a second housing may include a second recording device 110 (e.g., an auxiliary recording device). The first recording device 105 may capture incident information independent of the second recording device 110. The second recording device 110 may capture incident information independent of the first recording device 105. The first recording device 105 and the second recording device 110 may cooperate to capture incident information. The first recording device 105 may instruct the second recording device 105 to capture incident information.

In various embodiments, the first recording device 105 may be configured to control operation of the second recording device 110. The first recording device 105 may comprise a user interface that enables a user of the recording system 100 to activate at least one of the first recording device 105, the second recording device 110, and/or an additional recording device (e.g., third recording device 115). For example, the user interface may comprise one or more buttons (i.e., one or more physical buttons, one or more portions of a touch screen that generate an input when touched by the user, etc.) that cause the first recording device 105 to initiate capture of incident information and/or activate an additional recording device (e.g., the second recording device 110, the third recording device 115, etc.).

Recording devices of recording system 100 may capture separate video data. For example, the first recording device 105 may capture first video data and the second recording device 110 may capture second video data. The first video data may contain first captured data and the second video data may contain second captured data. Captured data may comprise metadata such as location data, timestamps, device identifiers, user identifiers, and/or additional information associated with the respective video data. The first captured data may be at least partially the same as the second captured data (e.g., the first video data and the second video data may each capture the same incident information from different points of view). The first captured data may be at least partially different than the second captured data (e.g., the first video data may capture incident information that the second video data did not capture, the second video data may capture incident information that the first video data did not capture, etc.). For example, a first field of view associated with the first recording device 105 may at least partially overlap with a second field of view associated with the second recording device 110 such that a set of incident information is recorded by the first recording device 105 and the second recording device 110. Additionally, the first field of view may cause the first recording device 105 to record additional incident information not captured by the second recording device 110. Similarly, the second field of view may cause the second recording device 110 to record additional incident information not captured by the first recording device 105.

In various embodiments, the recording system 100 may additionally comprise a third housing comprising a third recording device 115. The third recording device 115 may capture incident information independent of one or more of the first recording device 105 and the second recording device 110. Alternatively, or in addition, the third recording device 115 may be instructed by the first recording device 105 to initiate capture of incident information. The third recording device 115 may cooperate with one or more of the first recording device 105 and the second recording device 110 to capture incident information. The third recording device 115 may capture third video data containing third captured data. The third captured data may be at least partially the same as one or more of the first captured data or the second captured data. The third captured data may be at least partially different than one or more of the first captured data and the second captured data. In some embodiments, the third recording device 115 may capture third video data tracking eye movement of the user during an incident. For example, the first field of view associated with the first recording device 105 and/or the second field of view associated with the second recording device 110 may at least partially overlap with a third field of view associated with the third recording device 115 such that a set of incident information is recorded by the first recording device 105, the second recording device 110, and/or the third recording device 115. Additionally, the first field of view may cause the first recording device 105 to record additional incident information not captured by the third recording device 115. Similarly, the second field of view may cause the second recording device 110 to record additional incident information not captured by the third recording device 115. Further, the third field of view may cause the third recording device 115 to record further incident information not captured by the first recording device 105 and/or the second recording device 110.

In various embodiments, the recording devices 105, 110, 115 may each comprise a body (e.g., housing) comprising mechanical features configured to couple recording devices to a respective surface. Recording devices 105, 110, 115 may be configured to couple (e.g., mount) to clothing, straps, harnesses, belts, and/or other mounting points associated with a user. Accordingly, the body of the recording devices may be configured to interface with an article of clothing or a mount assembly wore by and/or located on a user. In response to being mounted to the user, recording devices 105, 110, 115 may be positioned to capture incident information at a fixed position relative to the user. Alternatively, or in addition, recording devices 105, 110, 115 may be positioning to capture incident information at a dynamic position relative to the user (e.g., mounted on a tool, implement, vehicle, and/or other position that moves relative to the user). In some examples, the first recording device 105 may mount to a belt mount as shown in FIG. 1, a chest mount, or a shoulder mount on the user. The first recording device 105 may comprise a torso-mounted camera. In some examples, a second recording device 110 may mount to a shoulder mount, a head mount, or to an accessory (e.g., glasses or hat) on a user. The second recording device 110 may comprise a head-mounted camera. A fixed position of the second recording device 110 may be moveable relative to a fixed position of the first recording device 105. For example, a user may rotate their head, causing the fixed position of the second recording device 110 to move relative to, and independent of, the fixed position of the first recording device 105. In some examples, a third recording device 115 may mount to an accessory (e.g., glasses or hat) on a user. At least one of the recording devices 105, 110, 115 may comprise an eye-tracking camera that captures incident information associated with the user.

In various embodiments, at least one recording device of the recording devices 105, 110, 115 may communicate with other entities. For example, the first recording device 105 may comprise a communication circuit, a transceiver, and/or other network interface that enables communications to be transmitted to and received from one or more remote devices. The at least one recording device may communicate with computing device 120 of the recording system 100 via network 102. In some embodiments, a first recording device 105 may communicate with other entities of recording system 100 via network 102, and other recording devices 110, 115 may communicate with first recording device 105 via wired and/or wireless communications. In other embodiments, each recording device of the recording devices 105, 110, 115 may separately communicate with other entities of the recording system 100 via network 102.

Network 102 may include a cloud, cloud computing system, or electronic communications system or method that incorporates hardware and/or software components. Communication amongst the devices and systems over a network may be accomplished through any suitable communication channel, such as, for example, a telephone network, an extranet, an intranet, the internet, a wireless communication, local area network (LAN), wide area network (WAN), virtual private network (VPN), and/or the like.

Electronic communications between the systems and devices may be unsecure. A network may be unsecure. In other embodiments, and to provide secure communications, electronic communications disclosed herein may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

In various embodiments, recording system 100 may comprise a computing device 120 that is separate from and/or remote relative to one or more recording devices. The computing device 120 may be configured to process video data captured by the one or more recording devices. Computing device 120 may comprise a network interface, communications module, or communications application that includes instructions that cause the computing device to establish a communication link between other computing devices or recording devices via the network 102. In some embodiments, the communication links described herein are peer-to-peer communication links. In other embodiments, the communication links described herein are server-mediated communication links. In other embodiments, the communication links described herein use one or more protocols, such as the internet protocol, mobile telephony protocols, push-to-talk over cellular protocols, and the like.

The computing device 120 may comprise a remote computing device. The remote computing device may comprise a dispatch device or user terminal. Computing device 120 may comprise a laptop computer, desktop computer, mobile phone, or other computing device. In some embodiments, the computing device 120 may comprise a user input device (e.g., a mouse and/or keyboard) and a display enabling a user of the computing device to view and interact with content stored and maintained by the computing device. In some embodiments, computing device 120 may be associated with a user ID.

In various embodiments, computing device 120 may additionally or instead comprise a server or cloud-computing infrastructure configured to host and maintain operation of processing algorithms for generating simulated video data from video data. For example, computing device 120 may comprise an evidence management system. In embodiments, computing device 120 may comprise one or more remote computing devices configured to simulate user perception by performing one or more operations further disclosed herein.

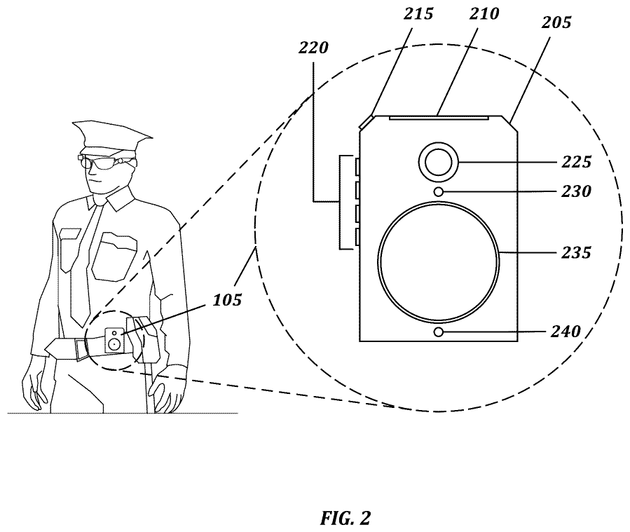

In various embodiments, and with reference to FIG. 2, a recording device is described. In particular, the recording device depicted by FIG. 2 may represent recording devices 105, 110, 115, and/or other recording devices that may be utilized by the recording system 100. As previously noted, a recording device may be configured to capture a visual point of view at least partially aligned with a point of view of the incident responder. Alternatively, the recording device may be configured to capture a visual point of view unassociated with the point of view of the incident responder (e.g., mounted to a vehicle associated with the incident responder).

In various embodiments, the recording device depicted by FIG. 2 may be a configuration of recording device 105. In particular, the recording device 105 may comprise a device housing 205, a first user interface 210, a second user interface 215, a third user interface 220, a video recording component 225, an output interface 230, a fourth user interface 235, an audio recording component 240, and/or other components associated with the recording device. In particular, various user interfaces can be associated with receiving inputs from a user and/or providing indications to the user. For example, user interfaces can be configured to receive indications from the user via buttons, switches, levers, toggles, dials, sliders, and/or other mechanisms that are associated with a set of inputs. Additionally, user interfaces can be configured to output indications to the user via speakers, screens, haptic feedback devices, and/or other mechanisms that are associated with a set of outputs. Further, user interfaces can be configured to both receive indications from and output indications to the user via touch screen interfaces, audio interfaces (e.g., verbal commands and responses), and/or other mechanisms associated with a set of inputs and a set of outputs.

In various embodiments, the recording device may comprise a device housing 205 configured to contain one or more internal components of the recording device and/or secure one or more components of the recording device. Device housing 205 may be formed from one or more materials selected for formation into the device housing 205, protection of various components of the recording device, durability of the device housing 205, and/or other design considerations associated with the device housing 205. For example, the device housing 205 may be formed from metallic, elastomer, plastic, fibrous, and/or other suitable materials selected according to device housing functionality. Additionally, device housing 205 may be configured to partially and/or wholly enclose one or more components of the recording device.

In various embodiments, first user interface 210 may be configured as a screen utilized to provide one or more notifications, requests, instructions, and/or other indications for viewing by a user of the recording device. For example, a processor of the recording device may be configured to cause first user interface 210 to display an indication to the user in response to a rule set. Alternatively, or in addition, the processor of the recording device may be configured to prompt the user, via the first user interface 210, to provide input via an additional user interface of the recording device. Additionally, first user interface 210 may be utilized in parallel with one or more additional user interfaces to navigate a menu, a prompt, and/or other functionality of the recording device (e.g., navigate a settings menu, select a desired device mode, provide a selected input from a set of inputs, etc.). Further, first user interface 210 may be configured as a touch screen interface.

In various embodiments, second user interface 215 and third user interface 220 may be configured as one or more input interfaces (e.g., button, switch, lever, toggle, dial, slider, etc.). Each of second user interface 215 and third user interface 220 may be separate from first user interface 210. A processor of recording device 205 may receive distinct input signals from each of first user interface 210, second user interface 215, and third user interface 220. Second user interface 215 and/or third user interface 220 may be utilized by a user of the recording device to activate, deactivate, navigate, interact with, and/or otherwise manage functionality of the recording device. For example, second user interface 215 may be configured as a power button that alters a power state of the recording device between “on” and “off.” Additionally, third user interface 220 may be configured as a navigation interface that includes “next,” “select,” and/or “previous” buttons for navigating menus and/or functionality associated with the recording device.

In various embodiments, video recording component 225 and audio recording component 240 may be configured to capture incident information associated with an incident. In particular, video recording component 225 and/or audio recording component 240 can be activated and/or deactivated by at least one of the user interfaces associated with the recording device (e.g., first user interface 210, second user interface 215, third user interface 220, fourth user interface 235, etc.). Additionally, video recording component 225 and/or audio recording component 240 may be configured for co-activation (e.g., an input causes video recording component 225 and audio recording component 240 to begin recording), independent activation (e.g., a first input causes video recording component 225 to begin recording and a second input causes audio recording component to begin recording), co-deactivation, and/or independent deactivation.

In various embodiments, video recording component 225 may be configured as a camera that records incident information. Similarly, audio recording component 240 may be configured as a microphone that records information. In particular, an in response to an activation instruction, video recording component 225 and/or audio recording component 240 may be activated and initiate capture of visual incident information and/or audio incident information.

In various embodiments, output interface 230 may be configured to provide one or more indications to a user of the recording device. In particular, output interface 230 may be configured to operate in parallel with at least one of the user interfaces. Alternatively, or in addition, output interface 230 may be utilized by the processor of the recording device to provide the one or more indications to the user in response to a recording device state and/or a detected occurrence. For example, output interface 230 may be configured as a speaker that produces an audible signal to the user of the recording device.

In various embodiments, fourth user interface 235 may be configured as one or more input interfaces and/or one or more output interfaces. For example, fourth user interface 235 may be configured as a button, switch, lever, toggle, dial, slider, and/or other input mechanism associated with functionality provided by the recording device. Alternatively, or in addition, fourth user interface 235 may be configured as a speaker, screen, LED system, and/or other output mechanism associated with functionality provided by the recording device. Fourth user interface 235 may be configured to initiate capture of incident information associated with an incident. Additionally, fourth user interface 235 may be configured to provide one or more indications of recording device state and/or recording device mode. Fourth user interface 235 may be separate, and provide discrete input signals, relative to first user interface 210, second user interface 215, and third user interface 220.

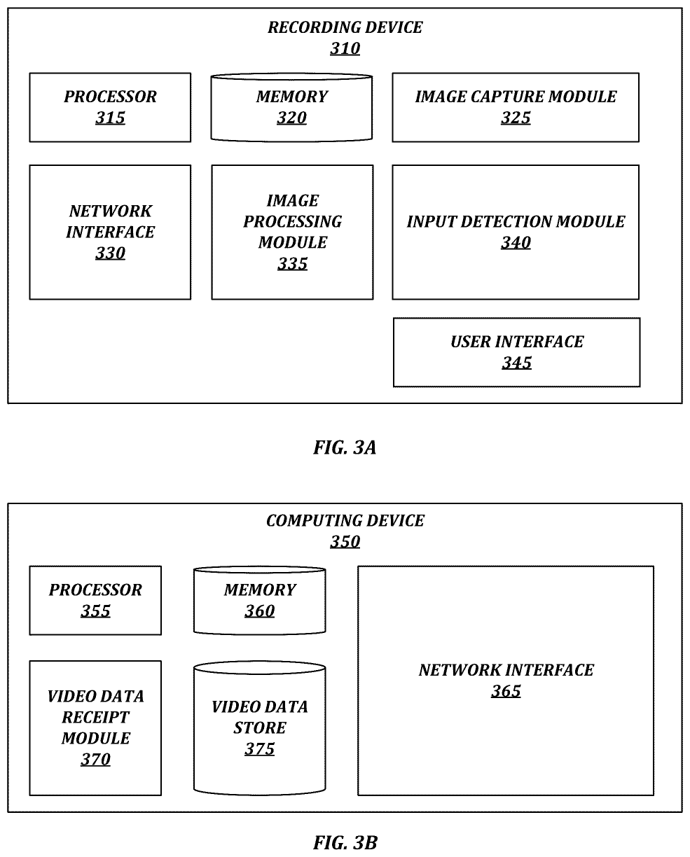

In various embodiments, and with reference to FIG. 3A, an exemplary recording device 310 is disclosed. Recording device 310 may comprise any suitable device configured to capture incident information. Recording device 310 may comprise a camera. For example, recording device 310 may comprise a body-worn camera, an in-vehicle camera, a smart phone, or the like. In various embodiments, recording device 310 comprises a body configured to house (fully and/or at least partially) various mechanical, electrical, and/or electronic components configured to aid in performing the functions of recording device 310. Recording device 310 may perform the function of one of recording devices 105, 110, or 115 with reference to FIG. 1.

In the example embodiment of FIG. 3A, recording device 310 comprises processor 315, memory 320, network interface 330, image capture module 325, image processing module 335, input detection module 340, and/or user interface 345. In various embodiments, recording device 310 may comprise additional or fewer modules, and processes performed by modules described herein may be in part or in whole performed by other modules or entities of the recording system 100.

In various embodiments, the processor 315 may be configured as a processing circuit that performs, triggers, manages, and/or otherwise operates various functions associated with the recording device 310. In particular, the processor 315 may be configured to execute a rule set for managing one or more inputs received via one or more user interfaces to perform the various functions associated with the recording device 310. The processor 315 may be configured to provide and receive electrical signals (e.g., digital signals, analog signals, etc.) that enable performance of the various functions. Additionally, the processor 315 may be configured to access indications stored in memory 320 and/or available via network interface 330. Further, processor 315 may be configured to control operation of various components of recording device 310, image capture module 325, image processing module 335, input detection module 340, user interface 345, and/or other components associated with recording device 310.

In various embodiments, the memory 320 may comprise one or more memory structures, data structures, or the like configured to store data, programs, and/or instructions. The memory 320 may be configured to receive and/or store one or more indications received from processor 315, image capture module 325, network interface 330, image processing module 335, input detection module 340, and/or user interface 345. Additionally, the memory 320 may be accessed by various components of the recording device 310 to acquire the one or more indications stored by memory 320.

In various embodiments, the network interface 330 may be configured to enable the transmission and/or reception of data between recording device 310 and one or more additional devices, servers, networks, or the like. For example, the network interface 330 may be configured to enable the transmission and/or reception of data between recording device 310 and an auxiliary recording device of recording system 100 (e.g., between recording device 105 and auxiliary recording device 110 of FIG. 1). The network interface 330 may be in electric and/or electronic communication with the processor 315 and/or the memory 320. The network interface 330 may comprise one or more suitable hardware and/or software components capable of enabling the transmission and/or reception of data, such as, for example, a communications unit, a transmitter, and/or a receiver. In various embodiments, recording device 310 may have a receiver configured to receive data (e.g., images, video, etc.) from an auxiliary recording device and/or other entities of the recording system 100. In various embodiments, recording device 310 may have a transmitter and a receiver to transmit data (e.g., instructions) to and receive data (e.g., images, video, etc.) from an auxiliary recording device and/or other entities of the recording system 100.

In various embodiments, image capture module 325 may be configured to capture an image or series of images (e.g., video). For example, during an incident recording, image capture module 325 may be configured to capture an image or series of images of the incident recording. Image capture module 325 may comprise various hardware and/or software components configured to capture images and/or video. For example, image capture module 325 may comprise one or more image sensors, one or more optical elements, and/or one or more image processors configured to capture images and/or video. An image sensor of the one or more image sensors may capture narrow angle field of view, a wide angle field of view, and/or the like.

In various embodiments, one or more optical elements of image capture module 325 may comprise one or more camera lenses (e.g., a multi-lens image capture module). For example, image capture module 325 may comprise a forward capture lens configured to capture images at least partially forward the user, and a rearward capture lens configured to capture images at least partially rearward the user. An image capture module 325 may also comprise one or more side or profile capture lenses configured to capture images peripheral the user. A processor of the camera may coordinate with the plurality of camera lenses to capture images at a same time, or near same time. The one or more optical elements, in combination with one or more image sensors of image capture module 325, may be configured to capture an image having a narrow angle field of view or a wide angle field of view.

In various embodiments, image capture module 325 may comprise an omnidirectional image capture module. The omnidirectional image capture module may be configured to capture a 360 degree field of view relative to the body of recording device 310. The omnidirectional image capture module may comprise a camera lens having a 360 degree field of view, or a plurality of camera lenses enabling a 360 degree field of view. The omnidirectional image capture module may be configured to output images and/or series of images as monoscopic video or stereoscopic video.

In various embodiments, image capture module 325 may comprise an infrared image capture module. The infrared image capture module may comprise any suitable infrared image capture module, including short wavelength infrared (SWIR), medium wavelength infrared (MWIR), and/or long wavelength infrared (LWIR). The infrared image capture module may be configured to detect infrared energy (heat), convert the detected infrared heat into an electronic signal, and process the electronic signal to produce a thermal image.

Image capture module 325 may be in electric and/or electronic communication with the processor 315 and/or the memory 320. The processor 315 may control (e.g., instruct) image capture module 325 to begin capturing images and to end capturing of the images. The processor may also control (e.g., instruct) image capture module 325 to transmit the captured images to the memory 320 for storage. Image capture module 325 may transmit (e.g., stream) the captured images to the memory 320 as the images are captured or in response to image capture module 325 ending capturing of the images.

In various embodiments, a recording device may not comprise an image capture module. In that regard, in order to capture images of an incident the recording device may communicate with an auxiliary recording device configured to capture images. The auxiliary recording device may comprise an image capture module. In various embodiments, the auxiliary recording device may comprise a body or housing separate from the body or housing of the recording device. The auxiliary recording device may comprise a body or housing detachable from the body or housing of the recording device, or may be in wired or wireless connection with the recording device.

Image processing module 335 may apply one or more processing algorithms to image data. For example, image processing module 335 may adapt brightness and/or stabilization of image data, may apply object recognition algorithms to image data, may apply license plate recognition algorithms to the image data, or the like. In other examples, image processing module 335 may modify or apply other processes or algorithms to image data, such as, for example, modifying an aspect ratio, modifying a file type, or the like.

In some embodiments, one or more processing algorithms may be applied by computing device 350 in addition to or instead of by recording device 310.

Input detection module 340 receives inputs from a user of recording device 310 and performs one or more actions based in part on the received inputs. Input detection module 340 may comprise one or more buttons, touch interfaces, audio interfaces (e.g., microphones), accelerometer, and the like. Alternatively, or in addition, input detection module 340 may be a virtual module that comprises a set of instructions executed by processor 315 to evaluate inputs received from one or more user interfaces. Inputs may comprise for example, button presses, voice inputs, and/or other interactions with an interface of recording device 310, the inputs configured to cause the recording device to perform an action, such as beginning or ending video data capture, transmitting captured video data, storing, processing, or modifying captured video data, or the like.

In various embodiments, inputs may be determined to be normal or abnormal. Normal inputs to the recording device may be associated with a set of expected thresholds and/or a set of input criteria. For example, normal inputs to the recording device may comprise one or more user interface inputs (e.g., button presses) having a length in a predetermined range of time (e.g., 3 to 5 seconds, etc.), voice commands being of a set of recognized voice commands and/or within a predetermined range of volume, and/or other input formats. In some embodiments, abnormal inputs to the recording device may comprise one or more inputs received via the one or more user interfaces that satisfy a set of abnormal thresholds and/or fail to satisfy the set of expected thresholds. For example, abnormal inputs to the recording device may comprise one or more of: one or more of button presses within a threshold amount of time (e.g., 10 seconds), at least one button press lasting less than a threshold amount of time (e.g., 1 second, 2 seconds, 3 seconds, 5 seconds, etc.), at least one button press lasting more than a threshold amount of time (e.g., 5 seconds, 10 seconds, 30 seconds, 1 minute, etc.), or other interactions with one or more interfaces of the recording device that do not fall within expected thresholds. In some embodiments, an input may be determined to comprise an abnormal input in accordance with a number of actuations of a user interface input. Alternately or additionally, an input may be determined to comprise an abnormal input in accordance with a duration of a single actuation of a user interface input.

In various embodiments, and in response to one or more inputs being received via the one or more user interfaces, processor 315 and/or input detection module 340 may determine whether the received input is a normal input and/or an abnormal input. An abnormal input may be associated with accidental interaction between recording device 310 and a user of recording device 310. In particular, one or more abnormal inputs may occur when users do not intend to perform, trigger, and/or otherwise cause actions associated with the one or more abnormal inputs. As such, input detection module 340 be configured to determine whether a received input is a normal input or an abnormal input and perform one or more actions associated with the normal input. In some embodiments, input detection module 340 may request confirmation prior to performing one or more additional action associated with the abnormal input. In some embodiments, input detection module 340 may provide alerts responsive to detecting an abnormal input, and may or may not perform actions associated with abnormal inputs.

In various embodiments, and responsive to detecting a received input to the recording device 310 by a user, processor 315 and/or input detection module 340 may determine that the received input is an abnormal input. For example, the received input may be an input to start video data capture, an input to end video data capture, an input to modify one or more settings of the recording device 310, and/or an input to transmit data and/or communications to one or more remote entities. Additionally, and in response to determining that the received input is an abnormal input, input detection module 340 may provide (e.g., transmit) a request for a user of the recording device 310 to confirm the input as intentional. In some embodiments, a request for confirmation may comprise displaying, by a visual interface of the recording device 310, a confirmation prompt. In other embodiments, a request for confirmation may comprise generating, by an audio element of recording device 310, an audio confirmation prompt.

In some embodiments, confirmation may comprise a second input by the user of the recording device 310. For example, second input may comprise a second button press meeting expected thresholds of normal inputs. In another example, second input may comprise a verbal confirmation by user of the recording device 310.

Responsive to receiving confirmation, input detection module 340 may transmit a notification to processor 315 to perform the action associated with the received input. Responsive to determining that the request is unconfirmed, input detection module 340 may not transmit a notification to processor 315 to perform the action associated with the received input, e.g., such that the action associated with the received input is not performed.

In various embodiments, and with reference to FIG. 3B, an exemplary computing device 350 is disclosed. Computing device 350 may comprise any suitable device configured to receive and process video data. For example, computing device 350 may comprise a laptop computer, desktop computer, mobile phone, or other computing device. Computing device 350 may, in some embodiments, alternately comprise a server and/or datastore. In various embodiments, computing device 350 comprises a body configured to house (fully and/or at least partially) various mechanical, electrical, and/or electronic components configured to aid in performing the functions of computing device 350. In embodiments, computing device 350 may perform functions of computing device 120 with reference to FIG. 1.

In the example embodiment of FIG. 3B, computing device 350 comprises processor 355, memory 360, network interface 365, video data receipt module 370, and video data store 375. In various embodiments, computing device 350 may comprise additional or fewer modules, and processes performed by modules described herein may be in part or in whole performed by other modules or entities of the recording system 100.

In various embodiments, the processor 355 may be in electrical, electronic, and/or mechanical communication with one or more components of computing device 350. For example, the processor may be in communication with the memory 360, the network interface 365, video data receipt module 370, and/or the like.

In various embodiments, the memory 360 may comprise one or more memory, data structures, or the like configured to store data, programs, and/or instructions. The memory 360 may be in electrical and/or electronic communication with the processor 355, the network interface 365, video data receipt module 370, and/or any other suitable component of the computing device 350. In an embodiment, the memory 360 may comprise a tangible, non-transitory computer-readable memory. Instructions stored on the tangible non-transitory memory may allow the processor to perform various operations, functions, and/or steps, as described herein. For example, in response to the processor executing the instructions on the tangible non-transitory memory, the processor 355 may communicate with video data receipt module 370 to process video data to generate simulated video data, as discussed further herein. As a further example, in response to the processor executing the instructions on the tangible non-transitory memory, the processor 355 may communicate with simulated video data store 375 to retrieve and/or display simulated video data. The processor may execute the instructions in response to operation of computing device 350 by a user, as discussed further herein.

In various embodiments, the network interface 365 may be configured to enable the transmission and/or reception of data between computing device 350 and one or more additional devices, servers, networks, or the like. For example, the network interface 365 may be configured to enable the transmission and/or reception of data between computing device 350 and a recording device of recording system 100 (e.g., between computing device 120 and recording device 110 of FIG. 1). The network interface 365 may be in electric and/or electronic communication with the processor 355 and/or the memory 360. The network interface 365 may comprise one or more suitable hardware and/or software components capable of enabling the transmission and/or reception of data, such as, for example, a communications unit, a transmitter, and/or a receiver.

Video data receipt module 370 receives video or image data from one or more recording devices of a user at an incident. In some embodiments, video data receipt module 370 establishes and maintains communications channels with one or more recording devices and may receive video or image data in real-time or in near real-time. In other embodiments, video data receipt module 370 may receive video or image data at periodic time intervals, responsive to a recording device ending video or image capture at an incident, or the like.

Video data receipt module 370 may apply one or more processing algorithms to received video or image data. For example, video data receipt module 370 may adapt brightness and/or stabilization of received video or image data, may apply object recognition algorithms to received video or image data, may apply license plate recognition algorithms to the received video or image data, or the like. In other examples, video data receipt module 370 may modify or apply other processes or algorithms to received video or image data, such as, for example, modifying an aspect ratio, modifying a file type, or the like. In some embodiments, one or more processing algorithms may be applied by a recording device 310 in addition to or instead of by computing device 350.

In some embodiments, video data receipt module 370 stores received video or image data. Video data receipt module 370 may store the received video or image data in association with information describing the video or image data. For example, video data receipt module 370 may associate received video data with one or more of: Incident identifier or event identifier, recording device identifier, user identifier, agency identifier, one or more timestamps, location data, or the like.

In some embodiments, received video or image data is stored in video data store 375. Video data store 375 may be any data store or data structure, or may be a component of a larger system comprising information about incidents, e.g., a dispatch system. Video data store 375 may store simulated video data in association with other information about the incident, including, for example, timestamps, location data, user identifiers, case numbers, or the like.

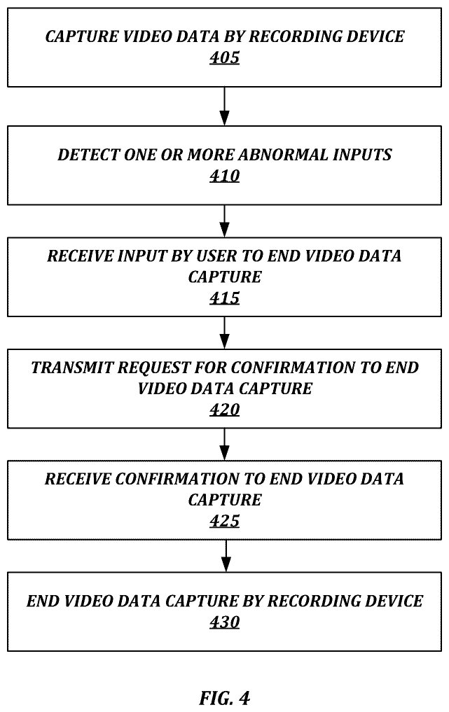

FIG. 4 is a flowchart illustrating a method for requesting confirmation for ending video data capture by a body-worn camera, according to some embodiments. For example, and in accordance with various embodiments, the method may include one or more steps for capturing video data by recording devices and ending video data capture responsive to detecting an abnormal input. In embodiments described in conjunction with FIG. 4, the method may be performed by one or more recording devices similar to any recording devices described herein, e.g., the recording device 310 of FIG. 3A. In other embodiments, the method may be performed in part or in whole by other entities of the recording system 100. In other embodiments, the method may comprise additional or fewer steps, and the steps may be performed in a different order than described in conjunction with FIG. 4.

In various embodiments, and at step 405 a recording device may be placed in an activated state such that the recording device captures video data associated with an incident. The recording device may be a body camera comprising a mount configured to attach to a user of the recording device. The recording device may attach to a torso of the user. In some examples, recording device may mount to a belt mount, a chest mount, a shoulder mount, a head mount, and/or another mount associated with a user at the incident. Additionally, recording device may apply one or more settings to the captured first video data. For example, the one or more settings may specify a field of view, a resolution, and/or an exposure time associated with capture of the first video data. Further, the recording device may comprise one or more algorithms to capture video data. The one or more algorithms may comprise a first algorithm for adapting to changes in brightness conditions, a first algorithm for adapting to motion or blur, and/or a first algorithm for detecting a focus point. In some embodiments, recording device may additionally apply one or more processing algorithms to first video data. The one or more processing algorithms may be applied to video data in real-time and/or after video data is captured.

In various embodiments, and at step 410, recording device may detect one or more abnormal inputs. In particular, the recording device may receive an input via a user interface and determine that the input is an abnormal input. As previously noted, one or more inputs received by the recording device may comprise, for example, button presses, voice inputs, and/or other interactions with a user interface of the recording device. Additionally, the one or more inputs may be categorized as one or more normal inputs and/or one or more abnormal inputs. The one or more normal inputs may be configured cause the recording device to perform an action, such as beginning or ending video data capture, transmitting captured video data, storing, processing, or modifying captured video data, or the like. The one or more abnormal inputs may be determined to be erroneous, unintended, and/or otherwise accidental interactions with one or more user interfaces of the recording device. Further, the recording device may substantially prevent the one or more abnormal inputs from triggering an associated action (e.g., the action that would result if an input was a normal input rather than an abnormal input). In some embodiments, a normal input and an abnormal input may be received via a user interface such that the normal input and the abnormal input are differentiated based at least on a set of thresholds associated with an input received by the recording device.

In various embodiments, one or more normal inputs received by the recording device may be associated with a set of thresholds that differentiate between a normal input and an abnormal input. For example, a normal input to the recording device may comprise a button press having a length in a predetermined range of time (e.g., 3 to 5 seconds, etc.), a voice command that is included by a set of recognized voice commands, a voice command within a predetermined range of volume, a set of button presses that are associated with a recognized button press sequence, and/or other sets of recognized inputs associated with one or more user interfaces. In some embodiments, abnormal inputs to the recording device may comprise an input to the recording device that does not satisfy the set of thresholds associated with one or more normal input and/or satisfies an additional set of thresholds associated with one or more abnormal inputs. For example, abnormal inputs to the recording device may comprise one or more of: a plurality of button presses within a threshold amount of time (e.g., 10 seconds), a sequence of button presses that are unrecognized by the recording device, at least one button press lasting less than a threshold amount of time (e.g., 3 seconds), at least one button press lasting more than a threshold amount of time (e.g., 5 seconds), a voice command outside of a range of volume, an unrecognized voice command, and/or other interactions with one or more user interfaces of the recording device that do not fall within the set of thresholds and/or satisfy the additional set of thresholds.

In various embodiments, the recording device, a processor of the recording device, an input detection module of the recording device, a computing device associated with the recording device, and/or other component associated with the recording device may be configured to identify one or more abnormal inputs from a set of received inputs. In particular, the recording device may receive an input via a user interface. In response the recording device may determine one or more input attributes. For example, the one or more input attributes may comprise input duration (e.g., button press duration, voice command duration, etc.), an input timestamp, input actions, input type, and/or other input attributes. Additionally, the recording device may determine whether the input is associated with a series of inputs received by the recording device. For example, the recording device may determine whether the input was received within a duration threshold associated with a previous input received by the recording device. Alternatively, or in addition, the recording device may be configured to permit a duration to elapse without receiving an additional input after receiving the input. The recording device may determine that the input is associated with a series of inputs where the input is received within the duration threshold after the previous input and/or the additional input is received within the duration after the input is received. Further, the recording device may evaluate the input independent of the series of inputs and/or as an individual input of the series of inputs.

In various embodiments, the recording device may determine an input type associated with an input received by the recording device. In particular, the recording device may determine a set of thresholds for determining whether the input is a normal input or an abnormal input based at least on the input type associated with the input. Input type may be indicative of the user interface that received the input (e.g., the input was received from a power button, from a begin recording button, a terminate recording button, etc.) and/or the action associated with the input (e.g., turn off recording device, stop recording incident information, begin recording incident information, transmit indication to a remote device, etc.). Additionally, the recording device may utilize a set of thresholds associated with the input type to determine whether the input is a normal input or an abnormal input. For example, the input may be associated with an input type of “event button pressed” that is associated with a duration threshold and a press sequence threshold. Accordingly, the recording device may evaluate whether the duration threshold is satisfied and whether the press sequence threshold is satisfied. In response to determining whether the set of threshold is satisfied, the recording device may determine whether the input is a normal input or an abnormal input.

In various embodiments, the recording device may determine a device state for the recording device. In particular, the recording device may utilize the device state to determine the set of thresholds utilized for evaluating whether an input is a normal input or an abnormal input. For example, receiving a power button input during recording of incident information may utilize a first set of thresholds and receiving the power button input during a standby state may utilize a second set of thresholds. Additionally, receiving an event button press while the recording device is recording incident information may utilize a first set of thresholds to determine whether incident information recording is to be terminated. Alternatively, receiving the event button press while the recording device is not recording incident information may utilize a second set of thresholds to determine whether incident information is to be initiated. It should be noted that while separate sets of thresholds may be utilized, the recording device may utilize a single set of thresholds independent of the device state.

In various embodiments, and at step 410, the recording device may determine that an input is an abnormal input. For example, the recording device may receive the input and determine a set of input attributes. The input attributes may indicate that the input comprises an event button press that has a duration of 7 seconds. Additionally, the recording device may determine that a set of thresholds associated with a normal input for the event button comprises a button press greater than 3 seconds in duration and less than 5 seconds in duration. Further, the recording device may determine that the set of thresholds is to be utilized based at least in part on the recording device being associated with a device state of capturing incident information when the input is received. Accordingly, the recording device may determine that the input is an abnormal input based at least on the input attributes, the device state, and/or the set of thresholds.

In various embodiments, and at step 415, the recording device may receive an input via a user interface to end video data capture. The recording device may select a set of thresholds associated with the user interface and/or an attempt to end video data capture to determine whether the input is a normal input or an abnormal input. Additionally, the input received via the user interface to end video data capture may be a single input associated with a set of inputs. In response to receiving the set of inputs, the recording device may utilize the set of thresholds to determine that the input is an abnormal input. Further, the set of inputs may comprise an additional input received that was received at a second time after a first time associated with the recording device receiving the input. An amount of time between the first time and the second time may place the additional input within a threshold period of time after determining that the input is an abnormal input and cause the additional input to be identified as an additional abnormal input (e.g., within 10 seconds of determining the input is an abnormal input).

In various embodiments, and at step 420, the recording device may transmit a request for confirmation regarding a recording device action associated with the abnormal input to a user of the recording device. In particular, and based at least in part on the recording device determining that the input to end video data capture is an abnormal input, the request for confirmation may be provided to the user via one or more user interfaces to confirm that the user wishes that the recording device action be executed despite the abnormal input determination. For example, the request for confirmation may confirm that the user intends to end video data capture and may comprise an audio output identifying the request for confirmation. Alternatively, or in addition, the request for confirmation may confirm that the user intends to end video data capture and may comprise a visual output (e.g., text on a screen or other visual interface of the recording device) displaying a confirmation prompt. Additionally, the user may provide confirmation via a confirmation input received at one or more user interfaces (i.e., the user may be prompted to provide an indication via a shared user interface that received the abnormal input, via a different user interface than the user interface that received the input, etc.). The confirmation input may be the same input type as the received input to end video data capture, e.g., an additional button press having a length in the predetermined range of time, an additional voice command to end video data capture, or may be of a different input type as the received input to end video data capture, e.g., a button press following a voice command, a specified interaction with another interface of the recording device, or the like.

In various embodiments, and at step 425, the recording device may receive confirmation to that a recording device action associated with the abnormal input is to be performed. In particular, the recording device may provide a request for confirmation to the user via one or more user interfaces and the user may submit the confirmation input corresponding to the request for confirmation. Additionally, the request for confirmation may indicate a user interface that the confirmation input is to be provided to. For example, the request for confirmation may indicate that the user is to provide the confirmation input (e.g., press “select” button, say “confirm” into microphone, etc.) via the indicated user interface (e.g., the “select” button, an activated microphone, etc.).

In various embodiments, the recording device may determine that the user has not confirmed the abnormal input received by the recording device. In particular, the recording device may provide the request for confirmation to the user via one or more user interfaces. Additionally, the request for confirmation may include and/or be associated with a confirmation window that the confirmation input is to be provided within. For example, the request for confirmation may be associated with a 10 second confirmation window for the confirmation input. In response to the receiving the confirmation input within the confirmation window, the recording device action associated with the abnormal input may be executed by the recording device. Alternatively, where the confirmation input is not received and/or is received outside of the confirmation window, the recording device action associated with the abnormal input may be substantially prevented, suppressed, and/or otherwise not executed. Accordingly, the recording device may determine that the abnormal input is to be canceled, suppressed, and/or otherwise ignored where the confirmation input is not detected in response to the request for confirmation.

Additionally, and at step 430, the recording device may determine whether the recording device action associated with the abnormal input is to be executed. In particular, and in response to receiving the confirmation input in response to the request for confirmation, the recording device may execute the recording device action. Alternatively, and in response to not receiving the confirmation input in response to the request for confirmation, the recording device may suppress the recording device action. For example, the recording device may end video data capture in response to the confirmation input being received. In some embodiments, the recording device may provide an alert to the user of the recording device responsive to one or more of receiving confirmation to end video data capture and/or ending video data capture. In some embodiments, the alert may be one or more of a visual alert, an audio alert, or a haptic alert. In some additional embodiments, the alert may additionally or instead comprise establishing a communications channel with one or more remote entities, such as, for example, a dispatch system, a user terminal, or another central system, and transmitting a notification to the one or more remote entities indicating ending video data capture by the recording device.

In some embodiments the recording device determines that the request for confirmation is unconfirmed responsive to failing to receive a second input from a user within a threshold amount of time, e.g., 10 seconds from the input to end video data capture. Responsive to determining that the request is unconfirmed, the recording device may continue to capture video data. In some embodiments, the recording device may provide one or more additional requests for confirmation responsive to determining that the request for confirmation is unconfirmed. In some embodiments, the recording device may additionally provide an alert responsive to determining that the request for confirmation is unconfirmed, e.g., an audio alert and/or a visual alert to identify that the recording device is continuing to capture video data. In some embodiments, the recording device may additionally or instead establish a communications channel with one or more remote entities and transmit a notification indicating that an input to end video data capture was received and not completed.

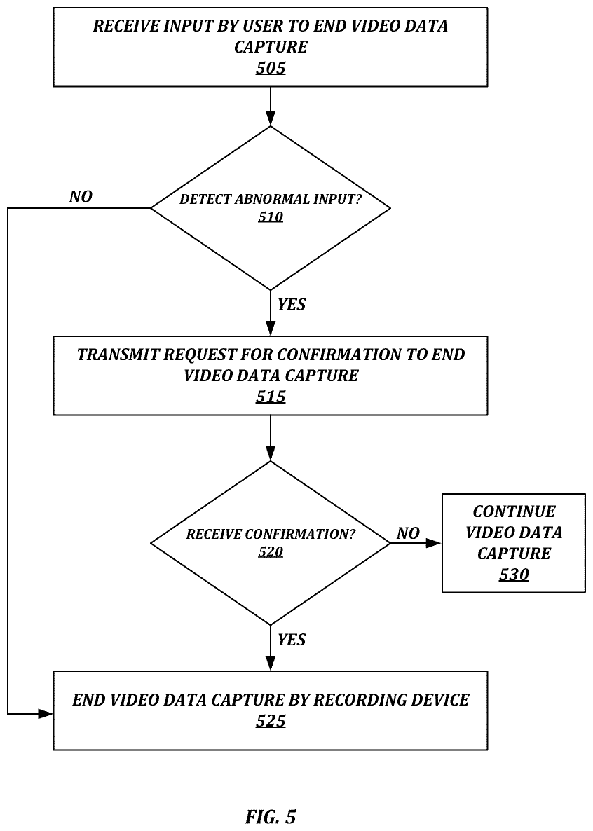

FIG. 5 is a flowchart illustrating a method for ending video data capture by a body-worn camera, according to some embodiments. For example, and in accordance with various embodiments, the method may include one or more steps for capturing by recording devices and ending video data capture. In embodiments described in conjunction with FIG. 5, the method may be performed by one or more recording devices similar to any recording devices described herein, e.g., the recording device 310 of FIG. 3A. In other embodiments, the method may be performed in part or in whole by other entities of the recording system 100. In other embodiments, the method may comprise additional or fewer steps, and the steps may be performed in a different order than described in conjunction with FIG. 5.

In various embodiments, a recording device may be associated with one or more device functions (e.g., capturing video, determining location, capturing audio, determining proximity to one or more additional devices, receiving indications with one or more additional devices, connecting with one or more additional devices, etc.). For example, the recording device may be configured as a body camera comprising a mount configured to attach to a user of the recording device. The recording device may attach to a torso of the user. In some examples, recording device may mount to a belt mount, a chest mount, or a shoulder mount of a user at an incident. Additionally, the recording device may apply one or more setting to a first captured data. For example, the first captured data may be first captured video data and one or more device settings may specify a field of view, a resolution, and/or an exposure time for the first captured video data. The recording device may additionally comprise one or more processing algorithms utilized by the recording device to capture and/or modify the first captured video data. For example, the one or more processing algorithms may comprise a first algorithm for adapting to changes in brightness conditions, a second algorithm for adapting to motion or blur, and/or a third algorithm for detecting a focus point. In some embodiments, recording device may additionally apply one or more processing algorithms to first video data. The one or more processing algorithms may be applied to video data in real-time and/or after video data is captured.

In various embodiments, and at step 505, the recording device may be in a first state and receive a user input to change the recording device from the first state to a second state. For example, and during video data capture, the recording device may receive an input by a user to end video data capture. Additionally, the user input to the recording device may comprise button presses, voice inputs, and/or other interactions with a user interface of the recording device. The user input(s) associated with the user interface may be configured to cause the recording device to perform an action, such as beginning data capture (e.g., audio data, video data, etc.), ending data capture, transmitting captured data, storing captured data, processing captured data, modifying captured data, and/or otherwise utilizing a function of the recording device. Further, the user input(s) may be determined to be a normal input or an abnormal input. As previously noted, with reference to FIG. 4, a normal input to the recording device may be determined to satisfy a set of thresholds associated with the user input. Similarly, an abnormal input to the recording device may be determined to satisfy an additional set of thresholds and/or fail to satisfy the set of thresholds associated with the normal input. Further, abnormal inputs may be associated with accidental inputs where a user of the recording device unintentionally presses one or more buttons of the recording device (e.g., during a physical confrontation, due to movement of a hand or arm near the recording device, during adjustment of the recording device, etc.). As such, abnormal inputs may occur when users do not intend to perform the recording device action associated with the abnormal input.

In various embodiments, and at step 510, the recording device may determine whether the user input is a normal input or an abnormal input. In particular, and based at least in part on receiving the user input to cause the recording device action, the recording device may utilize the set of thresholds to determine whether the user input is a normal input or an abnormal input. Additionally, the recording device may determine that the user input is a normal input and proceed to execute the recording device action associated with the user input. Alternatively, the recording device may determine that the user input is an abnormal input and proceed to generate a request for confirmation for the user input.

In various embodiments, and at step 515, the recording device may transmit a request for confirmation to the user of the recording device. In particular, and in response to the recording device determining that the user input is an abnormal input, the recording device may determine that the user input is an abnormal input and transmit the request for confirmation to the user via one or more user interfaces. The request for confirmation may include audio output, visual output, video output, and/or other indication of a confirmation input to the user that is to be provided to execute the recording device action associated with the abnormal input. For example, the request for confirmation may comprise an audio output indicating that the user is to press the “select” button to end video data capture. Alternatively, or in addition, the request for confirmation may comprise a visual output indicating that the user is to press the “select” button to end video data capture. The confirmation input provided by the user may be the same input type as the user input determined to be an abnormal input (e.g., a second button press having a length in the predetermined range of time, a second voice command to end video data capture, etc.) and/or may be of a different input type as the user input (e.g., a button press following a voice command, a specified interaction with another interface of the recording device, etc.).

In various embodiments, and at step 520, the recording device may determine whether the confirmation input was received. In particular, the recording device may utilize a response duration to determine whether the user submits the confirmation input in response to the request for confirmation. Where the confirmation input is received within the response duration, the recording device may proceed to step 525. Where the confirmation is not received and/or is received after expiration of the response duration, the recording device may determine that a subsequent input is independent of the abnormal input and evaluate the subsequent input at step 505. Alternatively, the recording device may transmit the request for confirmation and wait for the confirmation input to be submitted. The recording device may receive a subsequent input after transmission of the request for confirmation and determine whether the subsequent input is the confirmation input requested by the request for confirmation. Where the recording device determines the subsequent input is the confirmation input (e.g., the subsequent input was received via the user interface identified by the request for confirmation and/or comprises an indication requested by the request for confirmation), the recording device may proceed to step 525. Where the recording device determines the subsequent input is not the confirmation input, the recording device may suppress, cancel, and/or otherwise ignore the abnormal input and return to step 505 to evaluate the subsequent input.

In various embodiments, and at step 525, the recording device may execute the recording device action associated with the abnormal input. In particular, and in response to receive the confirmation input from the user, the recording device may determine that the abnormal input was an intentional input by the user and execute the recording device action associated with the abnormal input. For example, the recording device may determine that the abnormal input was followed by a confirmation input and subsequently terminate video data capture. Alternatively, and at step 530, the recording device may determine that the request for confirmation is unconfirmed, the recording device may suppress, cancel, and/or otherwise ignore the abnormal input. In some embodiments, the recording device may provide one or more additional requests for confirmation responsive to determining that a first request for confirmation is unconfirmed. The one or more additional requests for confirmation may be similar to a first request for confirmation and/may differ from the first request for confirmation. For example, a first request for confirmation may comprise an audio request for confirmation and the one or more additional requests for confirmation may comprise a visual request for confirmation.

In various embodiments, a recording device may be configured to execute a method for managing user inputs associated with video data capture associated with an incident. In particular, the recording device may be configured to be worn by a user and capture video data associated with an incident that the user is involved in. Additionally, the recording device may receive an input to end video data capture and determine that the input comprises an abnormal input. Further, and in response to determining that the input comprises the abnormal input, the recording device may transmit a request for confirmation to end the video data capture to the user via a user interface. The request for confirmation may go unanswered and the recording device may determine the that the request for confirmation is unconfirmed. As a result, the recording device may continue capture of video data associated with the incident.

In various embodiments, the abnormal input may comprise a button press hold lasting more than a threshold amount of time. For example, the threshold amount of time may be 1 second, 2 seconds, 3 seconds, 5 seconds, 5.5 seconds, 10 seconds, and/or other durations associated with triggering a recording device action by the user. Alternatively, or in addition, the abnormal input may comprise a plurality of button presses. Individual button presses of the plurality of button presses may be associated with a single duration and/or multiple durations. Additionally, each button press of the plurality of button presses may have a duration less than a threshold amount of time. Alternatively, the plurality of button pressures may occur within a threshold duration of each other. Further, a button press of the plurality of button presses may have a duration less than or alternatively greater than the threshold amount of time.

In various embodiments, the recording device may receive a second input to end the video data capture after the first input was suppressed. The recording device may determine that the second input to end the video data capture comprises a normal input. Accordingly, the recording device may terminate video data capture in response to determining that the second input comprises a normal input. Alternatively, the recording device may determine that the second input to end the video data capture comprises a second abnormal input. Similar to the first input, the recording device may transmit a second request for confirmation to end the video data capture to the user of the recording device. Further, the recording device may receive a confirmation input from the user to end the video data capture (e.g., pressing a “select” button indicated by the request for confirmation, pressing the user interface associated with the second input an additional time, speaking a voice command indicated by the request for confirmation, and/or other indication provided by the request for confirmation). Accordingly, the recording device may terminate video data capture in response to the confirmation input.

In various embodiments, the recording device may be configured to transmit a notification to a remote server (e.g., a server associated with a dispatch center, an administrative facility, a command facility, an evidence storage facility, etc.). In particular, the recording device may be configured to notify a remote device of user inputs received by the recording device, abnormal inputs received by the recording device, recording device actions suppressed based at least on an abnormal input, and/or abnormal inputs that are executed after a confirmation input is received. For example, the recording device may establish a communications channel with a remote entity and transmit, via the communications channel, a notification. As noted above, the notification may indicate the outcome of the abnormal input (e.g., suppression of associated recording device action, receipt of confirmation input, execution of associated recording device action, etc.). For example, the notification may indicate that the recording device terminated video data capture associated with an incident. Alternatively, or in addition, the recording device may transmit an alert to the user of the recording device responsive to detecting an abnormal input, receiving the confirmation, suppressing the associated recording device action, execution of the associated recording device action, and/or other actions taken in association with the abnormal input. For example, the alert can be an audible and/or visual notification of the video data capture being terminated by the recording device. The alert may comprise one or more of a visual alert, an audio alert, or a haptic (e.g., a vibration, a pulse, etc.) alert.

In various embodiments, a recording device may comprise an image sensor configured to capture video data associated with an incident, a non-transitory computer-readable storage medium storing computer-readable instructions, and a processor communicatively coupled to the image sensor and the computer-readable storage medium, the processor further configured to execute the instructions, wherein the instructions, when executed, cause the processor to perform a set of operations. For example, the operations may comprise capturing video data via the image sensor, receiving an input to end video data capture, determining that the input to end the video data capture comprises an abnormal input, and taking action to confirm the abnormal input. Additionally, the recording device may, in response to the abnormal input being detected, provide a request for confirmation to end the video data capture. Further, the recording device may determine that the abnormal input is unconfirmed and continue capture of the video data. It should be noted that the abnormal input may comprise at least one button press lasting less than a threshold amount of time.

In various embodiments, a recording device may be configured to manage a device state to avoid abnormal inputs altering the device state unintentionally. The recording device may receive a user input associated with a recording device action at a user interface of the recording device. Additionally, the recording device may determine, based at least on the user input, a set of input attributes associated with the user input. Similarly, the recording device may determine, based at least on the recording device action, a set of thresholds configured to determine whether the user input is assigned an abnormal input status. Further, the recording device may determine, based at least on the set of input attributes and the set of thresholds, that the set of input attributes associated with the user input satisfies the set of thresholds. As a result, the recording device may assign the user input the abnormal input status and provide a request for confirmation to the user of the recording device, the request for confirmation indicating the abnormal input status and requesting a confirmation input from the user. Accordingly, the recording device may suppress the recording device action associated with the user input based at least on the request for confirmation being unconfirmed.

In various embodiments, the device state may be a first device state. Additionally, the recording device action may be configured to cause the recording device to transition from the first device state to a second device state. Further, suppression of the recording device action associated with the user input may comprise substantially preventing the recording device from transitioning between the first device state to the second device state and causing the recording device to remain in the first device state. For example, the first device state may be associated with capturing incident information, not capturing incident information, a standby mode, an active mode, and/or other device state associated with the recording device. Accordingly, the second device state would respectively be not capturing incident information, capturing incident information, an active mode, a standby mode, and/or other altered device state associated with the recording device. The first device state and the second device state may be toggled states from each other (e.g., modifying the first device state causes the recording device to transition to the second device state and modifying the second device state causes the recording device to transition to the first device state). Alternatively, the first device state and the second device state may be part of a state cycle (e.g., modifying the first device state causes the recording device to transition to the second device state, modifying the second device state causes the recording device to transition to an additional device state device state, and modifying the additional device state causes the recording device to transition to the first device state and/or a further device state, etc.). Alternatively, the first device state and the second device state may be a selected state from a plurality of device states (e.g., modification of a current device state (e.g., first device state, second device state, third device state, additional device state, etc.) may comprise selecting an altered device state different from the current device state.

In various embodiments, the device state may comprise at least one of device recording status, user activity reporting, network connectivity status, data transmission status, and/or other device states associated with the recording device. Additionally, the user input may comprise at least one of a button press, an interaction with a screen (e.g., a touch input at a touch screen), a voice command, a gesture command, a series of button presses, a combination of inputs, a haptic interaction (e.g., shaking the recording device), and/or otherwise utilizing a user interface to provide the user input. Further, the user interface may comprise at least one of a button, a touch screen, a microphone, a camera, an inertial sensor, and/or other sensor associated with the recording device. Additionally, the set of input attributes may comprise at least one of an input duration, an input timestamp, a previous input timestamp, a previous input duration, a subsequent input timestamp, a subsequent input duration, and/or other input attribute. Further, the set of thresholds comprises at least one of a maximum input duration, a minimum input duration, a maximum duration between the user input and a previous input, a minimum duration between the user input and the previous input, a maximum duration between the user input and a subsequent input, a minimum duration between the user input and the subsequent input, and/or other threshold associated with the recording device action.

In various embodiments, the recording device may utilize a method for receiving a user input and evaluate the user input. In particular, the recording device may receive the user input via a user interface, the user interface associated with a recording device state and configured to execute a recording device action to modify the recording device state. Additionally, the recording device may determine a set of input attributes associated with the user input and determine, based at least on the recording device action, a set of thresholds configured to determine whether the user input is permitted to modify the recording device state. Further, the recording device may determine that the set of input attributes associated with the user input satisfies the set of thresholds and that the user input is an abnormal input. In response, the recording device may provide a request for confirmation to a user of the recording device, the request for confirmation requesting a confirmation input from the user. Accordingly, the recording device may suppress the recording device action from modifying the recording device state.

In various embodiments, the recording device may receive the confirmation input in response to the request for confirmation and execute the recording device action modifying the recording device state in response to the confirmation input. Additionally, receipt of the confirmation input by the recording device may comprise receiving the confirmation input during a confirmation duration associated with the request for confirmation. Alternatively, the recording device may determine that the request for confirmation is unconfirmed by the user. For example, the user may permit the confirmation duration to expire, submit an additional input other than the confirmation input, and/or otherwise not respond to the request for confirmation. Further, the recording device may determine, based at least in part on the request for confirmation being unconfirmed, that the user input is to be ignored (e.g., continue suppressing the abnormal input) and maintain the recording device state.

In various embodiments, the recording device may receive an additional user input via the user interface. In response, the recording device may determine an additional set of input attributes associated with the additional user input. It should be noted that the additional user input may be via a shared user interface associated with the user input and/or via a different user interface from the user input. Additionally, the recording device may determine, based at least on the additional set of input attributes and the set of thresholds, that the user input is a normal input. Further, the recording device may execute the recording device action associated with the additional user input to modify the recording device state. For the user interface comprises a button associated with the recording device action of transitioning the recording device between capturing a set of incident information and terminating capture of the set of incident information.

In some embodiments, the recording device may transmit an alert to the user of the recording device responsive to one or more of receiving confirmation to end video data capture, ending video data capture, determining the request for confirmation is unconfirmed, and/or continuing video data capture after an abnormal input to end video data capture. Alerts may be, for example, audio alerts, visual alerts, and/or haptic alerts. Alerts may vary based at least in part on associated event, e.g., an alert transmitted responsive to ending video capture may comprise a first alert type and an alert transmitted responsive to determining a request for confirmation is unconfirmed may comprise a second alert type.

In some embodiments, the recording device may additionally or instead establish a communications channel with one or more remote entities, such as a dispatch system or other central system. The recording device may transmit, to the one or more remote entities via the communications channel, a notification indicating one or more of receiving confirmation to end video data capture, ending video data capture, determining the request for confirmation is unconfirmed, and/or continuing video data capture after an abnormal input to end video data capture.

In various embodiments, a computer-based system may be appropriate for use in accordance with various recording device embodiments of the present disclosure. The accompanying description of a computer-based system may be applicable to servers, personal computers, mobile phones, smart phones, tablet computers, embedded computing devices, and other currently available or yet-to-be-developed devices that may be used in accordance with embodiments of the present disclosure.

A computer-based system may include a processor and a system memory connected by a communication bus. Depending on the exact configuration and type of computer-based system, system memory may be volatile or nonvolatile memory, such as read only memory (“ROM”), random access memory (“RAM”), EEPROM, flash memory, or other memory technology. Those of ordinary skill in the art and others will recognize that system memory typically stores data and/or program modules that are immediately accessible to and/or currently being operated on by the processor. In this regard, the processor may serve as a computational center of the computer-based system by supporting the execution of instructions. The processor may comprise one or more processing units, as discussed further herein. The system memory may comprise one or more memory units, as discussed further herein.

A computer-based system may include a network interface comprising one or more components for communicating with other devices and systems over a network. Embodiments of the present disclosure may access basic services that utilize the network interface to perform communications using common network protocols. The network interface may comprise a communications unit, as discussed further herein.

A computer-based system may also include a storage medium. However, services may be accessed using a computer-based system that does not include means for persisting data to a local storage medium. Therefore, the storage medium may be optional. The storage medium may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like. Storage medium 608 may include one or more memory units, as discussed further herein.

As used herein, the term “computer-readable medium” includes volatile and nonvolatile and removable and nonremovable media implemented in any method or technology capable of storing information, such as computer-readable instructions, data structures, program modules, or other data.

A computer-based system may include input devices, such as a keyboard, keypad, mouse, trackball, microphone, video camera, touchpad, touchscreen, electronic pen, stylus, and/or any other input device described herein. Such input devices may be coupled to the computer-based system by wired or wireless connections including RF, infrared, serial, parallel, BLUETOOTH®, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to a computer-based system (e.g., a client device), or can be integral components of a computer-based system. In some embodiments, multiple input devices may be combined into a single, multifunction input device (e.g., a video camera with an integrated microphone).

A computer-based system may also include output devices such as a display, speakers, printer, and/or any other output device described herein. The output devices may include video output devices such as a display or touchscreen. The output devices also may include audio output devices such as external speakers or earphones. The output devices can be separate from and communicatively coupled to the computer-based system, or can be integral components of the computer-based system. Input functionality and output functionality may be integrated into the same input/output device (e.g., a touchscreen). Any suitable input device, output device, or combined input/output device either currently known or developed in the future may be used with described systems.

In various embodiments, a “processing unit” as described herein may comprise any suitable hardware and/or software-based processing component. For example, a processing unit may comprise one or more of a processing circuit, a processor, an application specific integrated circuit (ASIC), a controller, a microcontroller, a microprocessor, a programmable logic device, logic circuitry, and/or the like.

In various embodiments, a “communications unit” as described herein may comprise any suitable hardware and/or software components capable of enabling the transmission and/or reception of data. A communications unit may enable electronic communications between devices and systems. A communications unit may enable communications over a network. Examples of a communications unit may include a modem, a network interface card (such as an Ethernet card), a communications port, etc. Data may be transferred via a communications unit in the form of signals which may be electronic, electromagnetic, optical, or other signals capable of being transmitted or received by a communications unit. A communications unit may be configured to communicate via any wired or wireless protocol such as a CAN bus protocol, an Ethernet physical layer protocol (e.g., those using 10BASE-T, 100BASE-T, 1000BASE-T, etc.), an IEEE 1394 interface (e.g., Fire Wire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZigBee® protocol maintained by the ZigBee alliance), a cellular protocol, an infrared protocol, an optical protocol, or any other protocol capable of transmitting information via a wired or wireless connection.

Two or more of the system components may be in electronic communication via a network. As used herein, the term “network” may further include any cloud, cloud computing system, or electronic communications system or method that incorporates hardware and/or software components. Communication amongst the devices and systems over a network may be accomplished through any suitable communication channel, such as, for example, a telephone network, an extranet, an intranet, the internet, a wireless communication, local area network (LAN), wide area network (WAN), virtual private network (VPN), and/or the like.

For the sake of brevity, conventional data networking, application development, and other functional aspects of system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

The foregoing description discusses preferred embodiments of the present invention, which may be changed or modified without departing from the scope of the present invention as defined in the claims. Examples listed in parentheses may be used in the alternative or in any practical combination. As used in the specification and claims, the words ‘comprising,’ ‘comprises,’ ‘including,’ ‘includes,’ ‘having,’ and ‘has’ introduce an open-ended statement of component structures and/or functions. In the specification and claims, the words ‘a’ and ‘an’ are used as indefinite articles meaning ‘one or more.’ While for the sake of clarity of description, several specific embodiments of the invention have been described, the scope of the invention is intended to be measured by the claims as set forth below. In the claims, the term “provided” is used to identify an object that is not a claimed element of the invention but an object that performs the function of a workpiece that cooperates with the claimed invention. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”. A person of ordinary skill in the art will appreciate that this disclosure includes any practical combination of the structures and methods disclosed. While for the sake of clarity of description several specifics embodiments of the invention have been described, the scope of the invention is intended to be measured by the claims as set forth below. Where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

No claim element is intended to invoke 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The words “herein,” “hereunder,” “above,” “below,” and other word that refer to a location, whether specific or general, in the specification shall refer to any location in the specification.

1. A method for capturing video data by a recording device, the method comprising:
capturing video data by the recording device worn by a user;
receiving an input to end video data capture;
determining that the input to end the video data capture comprises an abnormal input;
responsive to the abnormal input, transmitting a request for confirmation to end the video data capture; and
responsive to determining the request is unconfirmed, continuing to capture video data by the recording device.

2. The method of claim 1, wherein the abnormal input comprises a button press hold lasting more than a threshold amount of time.

3. The method of claim 2, wherein the threshold amount of time is 3 seconds or 5.5 seconds.

4. The method of claim 1, wherein the abnormal input comprises a plurality of button presses, each button press of the plurality of button presses lasting less than a threshold amount of time, and the plurality of button presses are received prior to the input to end the video data capture.

5. The method of claim 1, further comprising:
receiving a second input to end the video data capture;
determining that the second input to end the video data capture comprises a normal input; and
responsive to the second input, ending video data capture by the recording device.

6. The method of claim 1, further comprising:
receiving a second input to end the video data capture;
determining that the second input to end the video data capture comprises a second abnormal input;
responsive to the second abnormal input, transmitting a second request for confirmation to end the video data capture;
receiving confirmation to end the video data capture; and
responsive to receiving the confirmation, ending video data capture by the recording device.

7. The method of claim 6, wherein the confirmation to end the video data capture comprises one or more of: a button press, a verbal input, an interaction with a screen, or an indication provided via a user interface.

8. The method of claim 6, further comprising establishing a communications channel with a remote entity and transmitting, via the communications channel, a notification, the notification indicating the ending video data capture by the recording device.

9. The method of claim 6, further comprising transmitting an alert to the user of the recording device responsive to receiving the confirmation, the alert indicating the ending video data capture by the recording device.

10. The method of claim 9, wherein the alert comprises one or more of a visual alert, an audio alert, or a haptic alert.

11. A recording device, comprising:
an image sensor configured to capture video data;
a non-transitory computer-readable storage medium storing computer-readable instructions; and
a processor communicatively coupled to the image sensor and the non-transitory computer-readable storage medium, the processor further configured to execute the computer-readable instructions, wherein the computer-readable instructions, when executed, cause the processor to perform operations comprising:
capturing, via the image sensor, the video data;
receiving an input to end video data capture;
determining that the input to end the video data capture comprises an abnormal input;
responsive to the abnormal input, providing a request for confirmation to end the video data capture; and
responsive to determining the request is unconfirmed, continuing to capture video data by the recording device.

12. The recording device of claim 11, wherein the processor further performs operations comprising:
receiving a second input to end the video data capture;
determining that the second input to end the video data capture comprises a normal input; and
responsive to the second input, ending video data capture by the recording device.

13. The recording device of claim 12, wherein the normal input comprises a button press having a length in a predetermined range of time.

14. The recording device of claim 13, wherein the predetermined range of time comprises between three seconds and five seconds.

15. The recording device of claim 11, wherein the processor further performs operations comprising:
receiving a second input to end the video data capture;
determining that the second input to end the video data capture comprises a second abnormal input;
responsive to the second abnormal input, transmitting a second request for confirmation to end the video data capture;
receiving confirmation to end the video data capture; and
responsive to receiving the confirmation, ending video data capture by the recording device.

16. The recording device of claim 11, wherein transmitting the request for confirmation comprises displaying, via a user interface of the recording device, a confirmation prompt.

17. A method for receiving a user input for a recording device, the method comprising:
receiving the user input via a user interface, the user interface associated with a recording device state and configured to execute a recording device action to modify the recording device state;
determining a set of input attributes associated with the user input;
determining, based at least on the recording device action, a set of thresholds configured to determine whether the user input is permitted to modify the recording device state;
determining that the set of input attributes associated with the user input satisfies the set of thresholds;
determining, based at least on the set of thresholds being satisfied, that the user input is an abnormal input;
providing a request for confirmation to a user of the recording device, the request for confirmation requesting a confirmation input from the user; and
suppressing the recording device action from modifying the recording device state.

18. The method of claim 17, further comprising:
receiving the confirmation input, wherein the confirmation input is received during a confirmation duration; and
executing, based at least in part on the confirmation input being received, the recording device action to modify the recording device state.

19. The method of claim 17, further comprising:
determining that the request for confirmation is unconfirmed by the user; and
determining, based at least in part on the request for confirmation being unconfirmed, that the user input is to be ignored and maintaining the recording device state.

20. The method of claim 17, wherein the request for confirmation is determined to be unconfirmed in response to a confirmation duration expiring.
